(19) United States
(12) Patent Application Publication
(10) Pub. No.: US 2006/0226234 A1
(43) Pub. Date: Oct. 12, 2006

(54) Pharmaceutical dosage forms having overt and covert markings for identification and authentification

(76) Inventors: Frederick R. Kettinger, Norristown, PA (US); Charles D. Fields, Kent (GB); Thomas P. Farrell, Warrington, PA (US)

Correspondence Address: LUCAS & MERCANTI, LLP, 475 PARK AVENUE SOUTH, 15TH FLOOR, NEW YORK, NY, 10016, US

(21) Appl. No.: 10/560,368

(22) PCT Filed: Jun. 10, 2004
(86) PCT No.: PCT/US04/18463

§ 371 Date: Apr. 20, 2006

Related U.S. Application Data
(60) Provisional application No. 60/477,561, filed on Jun. 11, 2003.

(51) Int. Cl. G06K 19/00

(52) U.S. Cl. 235/487

(57) ABSTRACT

Oral solid dosage forms such as tablets having overt, printed or etched markings as well as optional covert markings are disclosed. The markings can be rapidly identified to authenticate a dosage form and/or drug contained therein. The inventive dosage forms include a core portion having sufficiently low friability to receive a printed or etched marking on a surface thereof, and a readable or detectable printed or etched marking on the surface of the core which provides information allowing the identification/authentication of the oral dosage form. In preferred aspects of this embodiment, a bar code, more preferably, a 2D data matrix bar code is printed or etched on a debossed region on the surface of the solid dose form. Methods of preparing the marked dosage forms and methods of identifying and/or authenticating solid dosage forms are also disclosed.

### CROSS-REFERENCE TO RELATED APPLICATIONS

This application claims the benefit of priority from U.S. Provisional Application Ser. No. 60/477,561, filed Jun. 11, 2003, the contents of which are incorporated herein by reference.

### FIELD OF THE INVENTION

This invention relates to pharmaceutical oral dosage forms having unique markings which allow it to be tracked and identified after leaving manufacturers' premises. Specifically, the invention relates to the use of visible indicators such as bar codes as well as covert markers which are imprinted or etched onto tablets and the like for the purposes of identification and authentication of a solid dose form in combination with or separate from filn coated systems and/color film coated systems.

### BACKGROUND OF THE INVENTION

In recent years there has been a need for increased control and tracking of pharmaceutical dosage forms. There have been suggestions to implement various tracking devices such as bar codes and hologram, etc on the bulk packages and unit dosage packs sent to pharmacies from manufacturers. Others have suggested employing bar codes on oral dosage forms as a way of increasing the tracking of the tablets. If the tablets could be scanned before being given to the patient by the healthcare provider, it is believed that there would be a significant reduction in medication administration errors in hospitals. Further information regarding the efforts in this regard are found, for example in U.S. Pat. Nos. 5,942,444, 5,992,742 and 6,543,692.

### SUMMARY OF THE INVENTION

In one aspect of the invention there is provided an oral solid dosage form such as a tablet having printed or etched markings thereon to identify and/or authenticate the dosage form and/or drug contained therein. The inventive dosage form includes

a) a core portion having sufficiently low friability to receive a printed or etched marking on a surface thereof; and

b) a readable or detectable printed or etched marking on the surface of the core which provides information allowing the identification/authentication of the oral dosage form.

In preferred aspects of this embodiment, a bar code, more preferably, a 2D data matrix bar code is printed or etched on a surface of the tablet or solid dose form.

For purposes of the present invention, 2D or 2d shall have its art recognized meaning with respect to bar code reading and identification.

For purposes of the present invention, the term “tablet” shall be understood to include all pharmaceutically acceptable solid dosages forms, including oral and non-oral compressed tablets, caplets, enrobed tablets, hard or soft (gelatin) capsules, press fit tablets and the like.

Additional embodiments of the invention include methods of preparing the marked dosage forms and methods of identifying and/or authenticating solid dosage forms. The method of preparing the uniquely identifiable oral dosage forms includes applying a readable printed or etched marking capable of providing identification authentication criteria on the surface an oral solid dosage form by the steps of:

a) providing a pharmaceutically acceptable core portion having sufficiently low friability to receive a printed or etched marking on a surface thereof; and

b) applying a readable printed or etched marking on the surface of said core. said marking of said oral dosage form.

In preferred aspects of this embodiment, the markings are applied using a pad printer or ink jet printer.

As a result of the present invention, there is provided a technology that allows a pharmaceutical company to distinguish among tablets and other dosage forms for the purpose of reducing medication errors and to enhance patient compliance. Pharmacies and hospitals or the like can also benefit from this identification system since the system does not reply on indicators which are easily copied by counterfeiters such as color, shape or word markings on tablets.

Another advantage of the present invention is that by employing covert marking such as molecular bar codes, the inventors have developed the ability to covertly authenticate pharmaceutical dosage forms using globally approved pharmaceutical markers. When combined with overt markings, the artisan has solid dosage forms which are always traceable and insure a high degree assurance that the intended dose is received by the patient to whom it is prescribed. The dosage forms of the present invention thus preferably allow for visual identification, electronic scanning identification, and immediate evidential (qualitative) in-field chemical identification. All of these technologies are commercially available at the present time and currently employ equipment that is available. Since the markings are applied directly to the dosage form itself, there is an added degree of assurance over similar markings applied to packaging materials such as manufacturers' containers or even unit dose packages, each of which must ultimately be separated from the dosage form prior to ingestion.

For purposes of the present invention, “molecular bar codes” shall be understood to mean any highly specific, engineered, if necessary, recognition molecules or amino acid sequences which can be used for the purposes of allowing detection and/or measurement, etc. or otherwise act as edible markers which are added to oral dosage forms for the purposes of being detected and providing a measurable, unique “fingerprint”.

For purposes of the present invention, “sufficiently low friability” shall be understood to mean that the compressed (oral) solid dosage forms marked using the techniques of the present invention can substantially withstand the processing steps and manipulations required to apply the markings described herein without causing significant breakage of the dosage forms.

For purposes of the present invention, the terms “readable” and “detectable” as used in conjunction with the markings applied to the dosage forms described herein shall be understood to embrace all such markings which can be recognized by optical apparatus, i.e. bar code reader, etc. or other detection devices such as HPLC, etc.

### BRIEF DESCRIPTION OF THE DRAWINGS

FIGS. 1-2 are photographs showing compressed tablets prepared in accordance with the present invention.

### DETAILED DESCRIPTION

The overt and covert markers of the present invention can be used for simple identification and authentication of the drug or solid dose form and may also be used as a chemical bar code system to provide information that may include but not be limited to:

source of manufacture, date of manufacture, manufacturing lot number, intended point of retail sale to comply with regulatory requirements, date of expiration, etc.

The invention includes the printed or etched bar code preferably film coated and/or color film coated to enable the commercial reliability of the imprinting or etching process to:

prevent ink bleed, enhance resolution, eliminate tablet dusting, eliminate and or reduce printing discontinuities and enhance reliability of electronic and or other scan identification techniques, equipment and processes. While a wide variety of tablet film coatings can be employed in carrying out the invention, preferred film coatings are capable of adhering to both the tablet core, which is typically a microcrystalline cellulose-based compressed tablet, and the marking which is preferably ink-based. A non-limiting list of suitable film coatings include those available from Colorcon under the OPADRY® and OPAGLOS® brand names. Generally, however, such suitable film coatings well known to those of ordinary skill will be based on a blend of a cellulosic polymer or polyvinyl acetate (PVA), plasticizer and other film coating ingredients.

The amount of film coating applied to the core before the marking is applied will depend upon the needs of the artisan, the type of marking applied and other parameters know to those of ordinary skill. Generally, the tablet cores are coated to a weight gain of from about 1 to about 5% by weight. Preferably, the film coatings are applied to weight gains of from about 2 to about 4% by weight.

The invention includes various printing and etching processes, preferably a pad printing process or an ink jet printing process. Laser etching of the tablet surface and/or the film coated surface is also contemplated using readily available technology and techniques known to those of ordinary skill.

In one preferred embodiment, the tablets are pad printed using an apparatus such as that described in PCT published application WO01/30573 A1, the contents of which are incorporated herein by reference. Such devices are capable of accurately and uniformly applying printing symbols and the like using a pad printer onto compressed tablets which are oriented on a conveyor unit at relatively high speed. The apparatus are also available from Printing International of Belgium.

As an alternative to the pad printing, ink jet printing of the markers onto the tablets can be employed. In such aspects of the invention, an ink jet printer replaces the pad printing device and the tablets are conveyed to the printer for marking(s). The ink jet printer allows for further identification of the tablets such as serialization (numbering of the tablets consecutively, etc.) without the need to stop the continuous printing process to change the printing pad or other marking device. Such modifications are said to be made in real time and allow a myriad of changes to be made. One such ink jet printer is available from Domino of Cambridge, UK. Alternatives include piezojet inkjet systems such those available from Xaar Technology Limited of Cambridge, UK or any other devices capable of delivering high resolution images onto oral solid dosage forms. Regardless of the printing apparatus employed, the ink selected for marking the tablets must be ingestible and meet all regulatory requirements for use in the pharmaceutical industry. Suitable inks include the OPACODE® brand inks available from Colorcon of West Point, Pa. Other inks will be apparent to those of ordinary skill.

In a still further aspect of the invention there is provided a method of etching the markings onto the surface of pharmaceutical cores or compressed tablets. Laser-based etching systems are employed to impart the desired images onto the surface of the tablets.

In another preferred aspect of the invention there is provided the ability to print or etch onto or into various shape tablets preferably with a debossed printing or etching surface and preferably a debossed flat printing or etching surface for the purposes of:

enhancing the resolution and printability or etching of the bar code into or onto the surface of the tablet and/or subsequent film coating; and/or depressing the logo below the surrounding surface of the tablet.

The oral solid dosage forms of this embodiment thus include a core or tablet surface having a debossed or recessed region into which the printed or etched marking is placed. The debossed region preferably has a substantially horizontal plane with respect to the center of said core and thus provides a flat or substantially flat area into which the markings can be placed. The debossed region can be made using a properly selected tablet tooling set having a convex punch on at least one of the upper and lower dies. The tablets containing the debossed region are then directed to the printer, such as via a conveyor system after being oriented to allow the recessed region to receive the printed marking.

The depressed logo and markings into the tablet provides the following benefits: protection from wear and abrasion of the bar code due to tablet handling equipment, packaging and prescription filling processes and equipment.

This invention is, however, not limited to the etching or imprinting into or onto a debossed flat surface, but also includes the imprinting or etching onto or into the surface of a flat or rounded or other shaped tablet surface.

The invention includes the ability to deboss the outline of a logo or tradename or symbol into the tablet to enhance identification of the tablet while providing a depressed and preferably flat surface for the imprinting or etching of the bar code onto or into the surface of a tablet or film coated tablet or other solid dose form.

The invention also includes the combination of color film coated tablets to enhance the identification of the tablet in preference with a color imprinted logo, symbol, tradename and/or bar code.

The invention includes the use of film coatings and or color film coatings to enable laser etching onto the surface of the tablet to create a multi-color logo or otherwise identification onto or into the solid dose form.

The invention can also include the use of film coatings and or color film coatings to enhance the adhesion and/or cohesion of an ink or other pigmented system into and or onto the surface of the film coated tablet or other solid dose form.

The invention includes the combination of the above combined with unique tablet shapes or unique color and tablet shape combinations to further enhance the identification of the tablet and/or drug.

The invention allows for the ready visual identification of the drug via its unique color and or shape and or markings such as a logo and/or symbol and or its debossed impressions and/or in combination with any or all of the preceding attributes of the tablet.

The invention includes the ability to electronically scan a tablet to readily identify the tablet and or drug. Such techniques are known to those of ordinary skill, see, for example U.S. Pat. Nos. 5,992,742 and 6,543,692, the disclosure of each of which is incorporated herein by reference.

The invention includes the stand alone identification of the drug through visual means, the stand alone identification of the drug through electronic scanning means and or the combination of identification through visual and electronic means.

As pointed out above, preferred aspects of the invention include the use 2d data matrix bar codes. Data Matrix is a matrix-type of 2D bar code that comes in a number of different array sizes and is identifiable by a finder pattern that occupies the perimeter of the optical code. The bottom and left edges of the code are solid black bars, forming an L-shaped pattern. The top and right edges of the code are made up of alternating black and white cells, allowing the reader to determine the number of rows and columns present in the matrix. The Data Matrix standard (ref) defines different types and levels of error correction, the preferred of which is ECC200. ECC200 uses a Reed-Solomon error correction scheme to allow the user to detect and correct a number of damaged bytes. Although most Data Matrix codes have an equal number of rows and columns, the standard allows for rectangular codes where there are twice the number of columns as rows.

Some 2D matrix codes can take on a number of allowed sizes or information densities. These types of codes must include easily detectable information that allows the reader to determine the bar code element size: the minimum height and width of a black or white area or “cell” in the code. Matrix codes typically possess a physical symmetry between the external size and the size of an individual cell. It is possible to determine the number of rows and columns of the matrix by knowing only the length of one side and the size of a single cell. For example, if an object within an image is found to be 100,000 pixels in height and the minimum distance between dark to light transitions is 7,962 pixels, the matrix height in elements can be calculated by dividing 100,000 by 7,962=13 elements high. For codes where only one physical size and information density is allowed, the number of rows and columns are known quantities. Although 2D bar codes are more compact than 1D codes, special care must be taken to ensure that the data stored in the code can be properly extracted. 1D codes provide “information redundancy” in the vertical direction. The taller the 1D codes, the greater the likelihood that a scan line will find and traverse an undamaged portion of the code thereby allowing a successful decode. 2D codes have built-in error detection and “error correction” data to allow the decoder to successfully decode a symbol even if part of the code is damaged or missing.

The invention includes the use of visible and or invisible pigments, colors and or inks to enable identification by light sources and scanning systems that do not rely upon visible light waves. A wide variety of suitable pigments and colorants are available from Colorcon, West Point, Pa. as well as other art recognized suppliers of pharmaceutically acceptable ingredients.

Additionally, the invention includes other detection equipment not dependent upon light waves such as chromatographic based or other analytical techniques to detect aroma and or taste, but not limited to aroma and or taste. Such other methods may include other types of markers as discussed below.

Covert Markers

The invention includes the use of covert markers in and/or on tablets, in and/or on film coatings and in or on inks or other pigment systems either visible or invisible to the human eye when applied to solid dose forms. The authentication systems included in the systems of the present invention are those which globally approved or approvable covert markers which can be employed without materially effecting the active ingredient included as part of the dosage form. The covert markers are also evidentially robust for loss prevention and protection concerns, as well as providing measures of patient and national security. The systems have been proven compatible and stable with color film coated systems for solid dosage form pharmaceutical and nutritional supplement applications.

Covert markers contemplated for use herein include those available from Biocode of Bethlehem, Pa. and described, for example in U.S. Pat. No. 5,942,444, the disclosure of which is incorporated herein by reference. The amount of the covert marking included will depend upon several factors including the specific marking selected, the tablets being treated, etc. For example, the covert marking can be included as part of the film coating or ink used for the marking of the tablets. Preferably, however, the covert marking is applied to the tablet as part of the film coating with amounts of up to about 5 parts per million (ppm)/tablet. The exact amount employed can also vary somewhat based on the individual marked selected and the needs of the artisan. Thus, in some embodiments of the invention there may be markers present in amounts beyond that mentioned above.

These covert markers cannot usually be detected by the human senses, and extremely difficult if not impossible to detect through normal analytical techniques. The markers can be incorporated into a solid dosage film coating to enshroud the solid dose form thereby providing a continuous security “package” in the form of a coating around the solid dose form. The covert marking system thus provides information amounting to a “chemical bar code” to render data such as source of manufacture, date of expiration, channel of distribution, origin, etc. Hence, the covert marker can serve as a carrier of information that extends beyond the NDC code which is contained in the 2D bar code on the surface of the film coated tablet or other solid dose form. Analysis of the covertly marked tablet can be done using the Biocode lateral flow device (LFD) to provide a quick qualitative visual confirmation of the presence of the marker. In use, the surface of the tablet suspected of containing the covert marking is wetted with a small amount of water and a portion of the run off is processed with the LFD to confirm the presence of the covert marker. If desired, additional confirmation of the presence of the marker can be had using other chromatographic methods including HPLC or GC, etc.

The covert markers can also be used to identify the film coating, and/or ink and/or other pigmented systems applied to or contained within the tablet as well as other excipients in the tablet and/or the drug/active ingredient contained within or on the solid dosage form.

This invention includes the use of covert markers alone or in combination with any of the described overt technologies discussed above or in combination with any combination of the described overt technologies discussed above.

### EXAMPLES

The following examples serve to provide further appreciation of the invention but are not meant in any way to restrict the effective scope of the invention.

### Example 1

### Color Contrast Evaluation Between 2-D Bar Code Inks and Color Film Coated Solid Dosage Forms

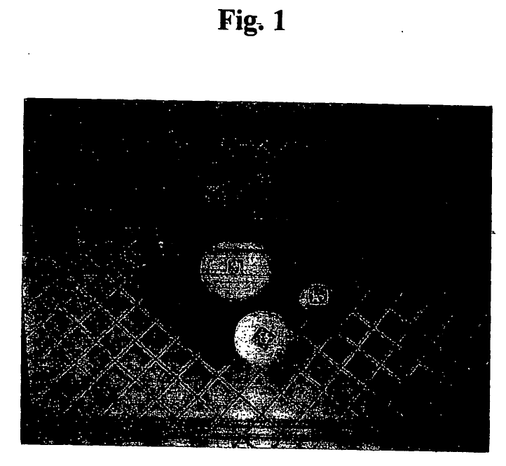

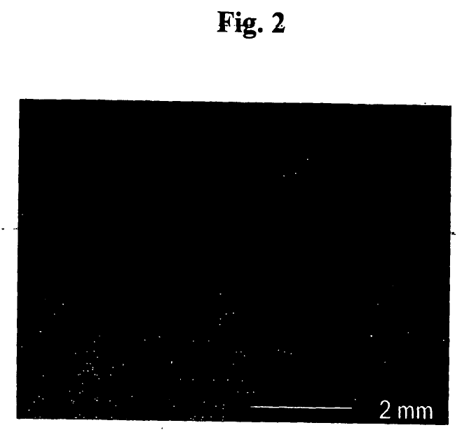

In this example, the feasibility of combining colored bar code ink applied to color film coated tablets was undertaken to determine color contrast requirements or limitations. The photographs attached hereto as FIGS. 1-2 provide the color combinations that have been tested and successfully scanned. A variety of placebo compressed cores (tablets), about 400 mg each, having a range of shapes and colors were top coated to a weight gain of about 3% using Opaglos® 2 (Colorcon) to one of the colors set forth in the Table below. The barcode was applied to the tablets using an Opacode® (Colorcon) ink in the colors shown in the Table using a Printing International pad printer model PI/290 Pa.

The following chart indicates the variety of bar code ink colors that can be combined with color film coated tablets and scanned using an Intermec Technologies high density Model 1470 scanner. To aid the reader, two examples of how to interpret the table below are provided:
1. A black ink color was scanned successfully on a white color film coated tablet 5 out of 5 times.

2. Black bar code ink on a purple film coated tablet was not successfully scanned due to the lack in color contrast between the bar code and the tablet surface color.

Color of Film Coated Tablet

| Color of Ink | White | Red | Purple | Yellow |
|---|---|---|---|---|
| Black | 5/5 | 5/5 | 0/5 | 5/5 |
| White | — | 0/5 | 5/5 | 0/5 |
| Yellow | 0/5 | 0/5 | 0/5 | — |
| Grey | 0/5 | 0/5 | 0/5 | 0/5 |
| Brown | 5/5 | 5/5 | 0/5 | 5/5 |
| Red | 5/5 | 0/5 | 0/5 | 5/5 |
| Blue | 5/5 | 5/5 | 0/5 | 5/5 |
| Green | 5/5 | 5/5 | 0/5 | 0/5 |

### Example 2

### Imprinting 2-D Bar Codes on Film Coated Tablets of Various Shapes

The minimum size of bar code for an NDC code was found to be 2.5 sq. mm when a black ink was printed onto a white flat faced tablet although this increased to 3.0 sq. mm when printed onto curved tablets and 4.0 sq. mm when on colored tablets; i.e.:

| | Round flat | Round normal | Round concave | | Round concave | Round double |
|---|---|---|---|---|---|---|
| | faced tablets | curvature tablets | tablets | Caplets | tablets | radius tablets |
| Tablet Size | (13 mm) | (10 mm) | (6.35 mm) | (19 × 7 mm) | (9.53 mm) | (9.53 mm) |
| Minimum Size | 2.5 | 3.0 | 3.0 | 4.0 | 4.0 | 4.0 |
| Bar Code | | | | | | |
| (Sq. mm) | | | | | | |

### Example 3

In this example, the process of Example 1 is repeated except that a covert marker is included in the film coating. Specifically, 0.04 wt % of a Biocode marker is added to the Opaglos 2 suspension before it is applied to the tablets. The final product is determined to have about 5 ppm of the covert marking per tablet.

### Examples 4-5

In these examples, the procedures of Examples 1 and 3 are repeated except that an ink jet printer is employed in place of the pad printer.

### Examples 6-7

### Serialization of 2D Bar Coded Imprints

In these examples, the procedures of Examples 4-5 are repeated except that the ink jet printer is modified to allow the individual tablets to be consecutively numbered (serialized) so that each tablet has a unique number.

### Example 8

In this example, the covertly marked tablets of Example 3 are tested using the LFD device of Biocode. Specifically, one of the tablets is wetted with water and the run off is directed to an LFD device and the presence of the marker is qualitatively confirmed.

Minimum Size Limitations of 2-D Bar Codes

The minimum size of the bar code required depends upon a number of factors; e.g.: number of digits being coded, resolution of scanner, curvature of substrate, and degree of color contrast between ink and substrate. The minimum size bar code that can contain the NDC code is 2.5 mm square. It is possible to reduce the size of the bar code further if the full NDC code is not required. The limits of the high-resolution bar code scanner may then be the determining limit for the minimum size of the 2-D data matrix bar code.

Reliability of 2-D Data Matrix Bar Code Symbology

2D Data matrix bar codes are robust and readable even when there is only a partial image present—we found we could lose some of the code within the border and still successfully scan.

What is claimed is:

1. An oral solid dosage form, comprising
a) a core portion having sufficiently low friability to receive a printed or etched marking on a surface thereof;
b) a readable printed or etched marking on the surface of said core, said marking providing identification/authentication of said oral dosage form.

2. The oral solid dosage form of claim 1, wherein said core is film coated prior to said printed or etched marking being applied thereto.

3. The oral solid dosage form of claim 1, wherein said printed or etched marking is a bar code.

4. The oral solid dosage form of claim 3, wherein said bar code is a 2D data matrix bar code.

5. The oral solid dosage form of claim 2, wherein said film coat contains a colorant.

6. The oral solid dosage form of claim 1, wherein said marking is readable with a bar code scanner.

7. The oral solid dosage form of claim 1, wherein said marking is readable with detection equipment which does not depend upon visible light waves.

8. The oral solid dosage form of claim 1, further comprising a covert marking thereon.

9. The oral solid dosage form of claim 1, wherein said covert marking is detectable by aroma or taste.

10. The oral solid dosage form of claim 8, wherein said covert marking is detectable using HPLC.

11. The oral solid dosage form of any of claims 1-10, wherein the surface of said core further comprises a debossed region into which said printed or etched marking is placed.

12. The oral solid dosage form of claim 11, wherein said debossed region has a substantially horizontal plane with respect to the center of said core.

13. The oral solid dosage form of claim 1, wherein said core has an ink coating applied to a portion thereof prior to said marking being applied thereto.

14. A method of applying a readable printed or etched marking which provides identification/authentication criteria on the surface an oral solid dosage form, comprising
a) providing a pharmaceutically acceptable core portion having sufficiently low friability to receive a printed or etched marking on a surface thereof;
b) applying a readable printed or etched marking on the surface of said core. said marking of said oral dosage form.

15. The method of claim 14, wherein said marking is applied via pad printing.

16. The method of claim 14, wherein said marking is applied via ink jet printing.

17. The method of claim 14, wherein said marking is etched onto a surface of said core.

18. The method of claim 14, further comprising debossing a surface region of said core and applying said marking in said debossed region.

19. The method of claim 14, further comprising film coating the surface of said the core prior to applying said marking.

20. The method of claim 14, further comprising applying a covert marking to said core.

21. The method of claim 20, wherein said printed marking is applied using an ink containing a covert marker therein.

22. The method of claim 15, wherein said pad printing is applied using an Opacode ink.

23. The method of claim 20, wherein the concentration of said covert marker is applied to the film coating in an amount sufficient to provide about 2 to about 5 ppm per tablet marked.

24. The method of claim 23, wherein the concentration of said covert marker is sufficient to provide about 4 ppm per tablet marked.
